(19) United States
(12) Patent Application Publication
(10) Pub. No.: US 2026/0066634 A1
(43) Pub. Date: Mar. 5, 2026

(54) POWER JUNCTION BOX WITH ADJUSTMENT MODULE

(71) Applicant: Zhuhai Shengchang Electronics Co., Ltd., Zhuhai City (CN)

(72) Inventors: Jialong HU, Zhuhai City (CN); Dehua ZHENG, Zhuhai City (CN)

(21) Appl. No.: 18/911,215

(22) Filed: Oct. 9, 2024

(30) Foreign Application Priority Data
Aug. 27, 2024 (CN) 2024220907400

(51) Int. Cl. H02G 3/08

(52) U.S. Cl. CPC H02G 3/081; H02G 3/088

(57) ABSTRACT

The present disclosure discloses a power junction box with an adjustment module, aiming to provide a power junction box that saves installation space and can directly adjust electrical parameters. The power junction box includes a main body, which is internally provided with a power chamber and wiring chambers, wherein the power chamber is internally provided with a circuit board; a power chamber cover plate and a wiring chamber cover plate are disposed on the main body and are respectively configured to cover the power chamber and the wiring chambers; and the power chamber cover plate is provided with the adjustment module and adjusting holes, the adjustment module is located inside the power chamber and is electrically connected to the circuit board, and the adjusting holes correspond to the adjustment module. The present disclosure is applied to the technical field of power junction boxes.

### TECHNICAL FIELD

The present disclosure relates to a power junction box, in particular to a power junction box with an adjustment module.

### BACKGROUND

A power junction box has the function of adjusting electrical parameters. The existing adjustment modules are usually installed on inner sides of wiring chambers, which not only occupy the spaces of the wiring chambers, but also are not convenient for users to adjust. Generally, the adjustment module is shielded by a housing and is not directly exposed to the outside, so that a user cannot directly determine the adjustment position. When electrical parameters need to be adjusted, an outer cover must be opened to determine the position before adjustment of the parameters.

### SUMMARY

In order to solve the technical problem of overcoming the shortcomings in the prior art, the present disclosure provides a power junction box that saves installation space and can directly adjust electrical parameters.

The technical solution adopted by the present disclosure is as follows: the present disclosure includes a main body, and the main body is internally provided with a power chamber and wiring chambers; the power chamber is internally provided with a circuit board; a power chamber cover plate and a wiring chamber cover plate are disposed on the main body and are respectively configured to cover the power chamber and the wiring chambers; and the power chamber cover plate is provided with an adjustment module and adjusting holes, the adjustment module is located inside the power chamber and is electrically connected to the circuit board, and the adjusting holes correspond to the adjustment module.

Further, the power chamber is spaced apart from the wiring chambers by means of a middle partition, and mounting ports are provided in the middle partition; the mounting ports penetrate between the power chamber and the wiring chambers, each of the mounting port is provided with a wire jacket, and threading holes are reserved in the wire jacket; and the wiring chambers are provided with first knock-out holes.

Further, two side plates are respectively disposed at two sides of the main body, mounting holes and second knock-out holes are reserved in the side plates, and the side plates are in threaded connection with the main body.

Further, positioning blocks are disposed on the side plates and are matched with the middle partition.

Further, each of the side plates is provided with a drain hole, and the wiring chamber cover plate is provided with a waterproof pad located inside the wiring chambers.

Further, there are at least one power chamber and at least two wiring chambers; and an isolating member is configured to separate the two adjacent wiring chambers.

Further, the isolating member is provided with a long-strip connecting hole, and the isolating member is in threaded connection with interiors of the wiring chambers by means of the long-strip connecting hole.

Further, the power chamber cover plate is connected to the main body through one of threaded connection, rotary connection, or clamping connection; and the wiring chamber cover plate is connected to the main body through one of threaded connection, rotary connection, or clamping connection.

Further, first buckles are respectively disposed at two sides of the power chamber, second buckles are respectively disposed at two sides of the power chamber cover plate, and the two second buckles are respectively clamped with the two first buckles.

Further, a rotating column is disposed on each of the side plates, a third buckle is disposed on one side of each of the wiring chambers, rotating holes are provided on one side of the wiring chamber cover plate, and a fourth buckle is disposed on the other side thereof; the rotating columns are rotatably connected to the rotating holes; and the fourth buckle is clamped on the third buckles.

The present disclosure has the following beneficial effects.

Compared with the shortcomings in the prior art, according to the present disclosure, due to the adjustment module being disposed on the power chamber cover plate and located inside the power chamber, the installation spaces of the wiring chambers can be avoided being occupied, and the adjustment module can be prevented from being affected by cables located in the wiring chambers during adjustment by the adjustment module; moreover, when the electrical parameters need to be adjusted, there is no need to open the power chamber cover plate or the wiring chamber cover plate, and the adjustment module can be directly adjusted through the adjusting holes in the case where both the power chamber cover plate and the wiring chamber cover plate are in a closed state; and therefore, the present disclosure has the advantages of saving installation space and being capable of directly adjusting electrical parameters.

### BRIEF DESCRIPTION OF THE DRAWINGS

In order to more clearly illustrate the embodiments of the present disclosure or the technical solutions in the prior art, a brief introduction will be given to the accompanying drawings required for the description of the embodiments or the prior art. Apparently, the accompanying drawings described below are merely some of the embodiments of the present disclosure, and for those of ordinary skill in the art, without creative efforts, other drawings can also be obtained based on the structures shown in these drawings.

FIG. 1 is a schematic diagram of the three-dimensional structure of the present disclosure;

FIG. 2 is a three-dimensional structural diagram of the internal structure of the present disclosure; and

FIG. 3 is an exploded view of the present disclosure.

The implementation, functional characteristics, and advantages of the present disclosure will be further described in detail with reference to the accompanying drawings in conjunction with the embodiments.

### DETAILED DESCRIPTION OF THE EMBODIMENTS

The technical solutions in embodiments of the present disclosure will be described clearly and completely hereinafter with reference to the accompanying drawings in the embodiments of the present disclosure. Apparently, the described embodiments are only a part rather than all of the embodiments of the present disclosure. Based on the embodiments of the present disclosure, all other embodiments obtained by those of ordinary skill in the art without making creative efforts shall fall within the protection scope of the present disclosure.

It should be noted that all directional indications, such as upper, lower, left, right, front, back, clockwise, counterclockwise . . . , in the embodiments of the present disclosure are only used to explain a relative position relationship and motion situation between components in a specific posture. If the specific posture changes, the directional indication also changes accordingly.

In addition, if there are descriptions related to “first”, “second”, and the like in the present disclosure, the descriptions of “first”, “second”, and the like are only used for descriptive purposes, and cannot be understood as indicating or implying their relative importance or implying the number of indicated technical features. Therefore, the features defined with “first” and “second” may explicitly or implicitly include at least one of these features. In addition, the technical solutions of various embodiments can be combined with each other, which must be based on what those of ordinary skill in the art can achieve. When the combination of the technical solutions is contradictory or impossible to achieve, it should be considered that the combination of such technical solutions does not exist and is not within the scope of protection of the present disclosure.

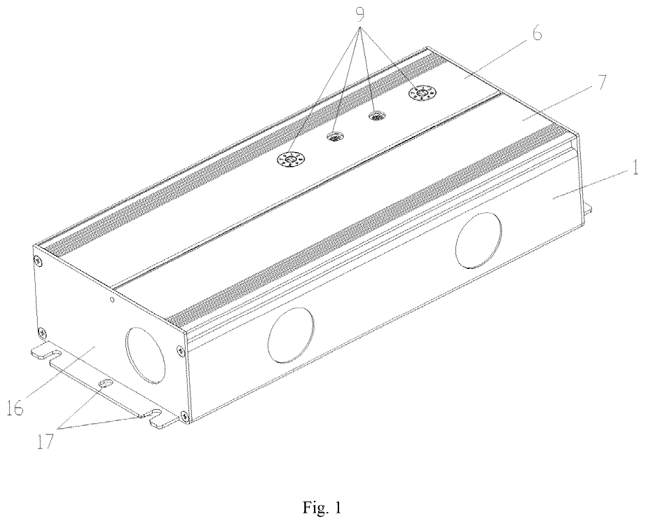

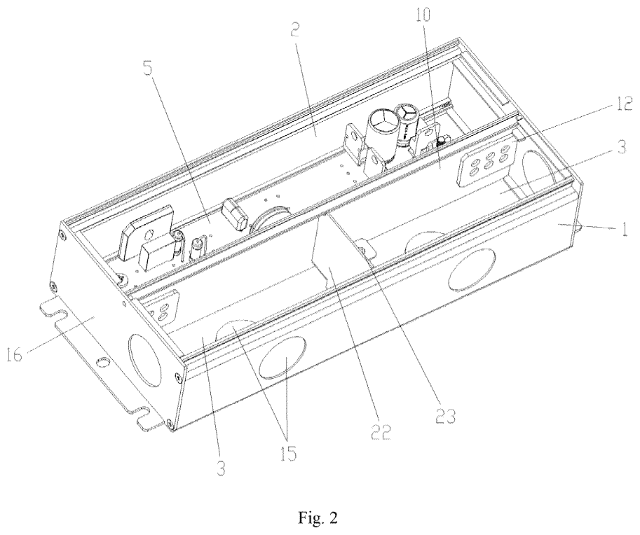

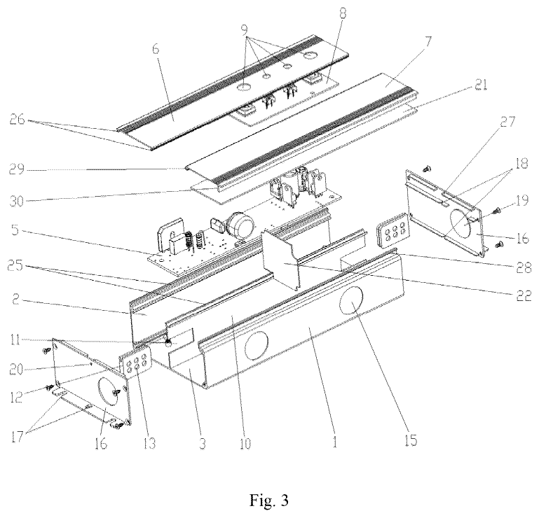

As shown in FIG. 1 to FIG. 3, according to the present disclosure, the present disclosure includes a main body 1, and the main body 1 is internally provided with a power chamber 2 and wiring chambers 3; the power chamber 2 is internally provided with a circuit board 5; a power chamber cover plate 6 and a wiring chamber cover plate 7 are disposed on the main body 1 and are respectively configured to cover the power chamber 2 and the wiring chambers 3; and the power chamber cover plate 6 is provided with an adjustment module 8 and adjusting holes 9, the adjustment module 8 is located inside the power chamber 2 and is electrically connected to the circuit board 5, and the adjusting holes 9 correspond to the adjustment module 8.

Compared with the shortcomings in the prior art, according to the present disclosure, due to the adjustment module 8 being disposed on the power chamber cover plate 6 and located inside the power chamber 2, the installation spaces of the wiring chambers 3 can be avoided being occupied, and the adjustment module 8 can be prevented from being affected by cables located in the wiring chambers 3 during adjustment by the adjustment module; moreover, when electrical parameters need to be adjusted, there is no need to open the power chamber cover plate 6 or the wiring chamber cover plate 7, and the adjustment module 8 can be directly adjusted through the adjusting holes 9 in the case where both the power chamber cover plate 6 and the wiring chamber cover plate 7 are in a closed state; and therefore, the present disclosure has the advantages of saving installation space and being capable of directly adjusting electrical parameters.

In some embodiments, the power chamber 2 is spaced apart from the wiring chambers 3 by means of a middle partition 10, and mounting ports 11 are provided in the middle partition 10; the mounting ports 11 penetrate between the power chamber 2 and the wiring chambers 3, each of the mounting port 11 is provided with a wire jacket 12, and threading holes 13 are reserved in the wire jacket 12; and the wiring chambers 3 are provided with first knock-out holes 15. Specifically, the wire jackets 12 are clamped inside the mounting ports 11, so that the cables can pass through the threading holes 13 located between the power chamber 2 and the wiring chambers 3 to achieve electrical connection. In addition, the plurality of first knock-out holes 15 are reserved in the wiring chambers 3 for cable penetration, which facilitates installation.

In some embodiments, two side plates 16 are respectively disposed at two sides of the main body 1, mounting holes 17 and second knock-out holes 19 are reserved in the side plates 16, and the side plates 16 are in threaded connection with the main body 1; and positioning blocks 18 are disposed on the side plates 16 and are matched with the middle partition 10. Threaded holes are respectively reserved at the two sides of the main body 1, and the two side plates 16 are connected in the threaded holes by means of screws; the mounting holes 17 are located at bottoms of the side plates 16; and the positioning blocks 18 are positioning ribs. Specifically, the mounting holes 17 are configured to realize the installation of the main body 1; in addition, the middle partition 10 is positioned and fixed by the positioning blocks 18; and the second knock-out holes 19 are provided on the side plates 16, so as to facilitate the passage of the cables.

In some embodiments, each of the side plates 16 is provided with a drain hole 20, and the wiring chamber cover plate 7 is provided with a waterproof pad 21 located inside the wiring chambers 3. Specifically, the waterproof pad 21 is disposed inside the wiring chambers 3 to provide a waterproof effect.

In some embodiments, there are at least one power chamber 2 and at least two wiring chambers 3; an isolating member 22 is configured to separate every two adjacent wiring chambers in the plurality of wiring chambers 3; the isolating member 22 is provided with a long-strip connecting hole 23, and the isolating member 22 is in threaded connection with interiors of the wiring chambers 3 by means of the long-strip connecting hole 23. Specifically, by connecting to the long-strip connecting hole(s) 23 by means of screws, the isolating member(s) 22 can separate two or more wiring chambers 3. Moreover, due to the setting of the long-strip connecting hole 23, the isolating member 22 can change the position of connection, so as to adjust the sizes of the wiring chambers 3 according to actual needs.

In some embodiments, the power chamber cover plate 6 is connected to the main body 1 through one of threaded connection, rotary connection, or clamping connection; and the wiring chamber cover plate 7 is connected to the main body 1 through one of threaded connection, rotary connection, or clamping connection.

In some embodiments, first buckles 25 are respectively disposed at two sides of the power chamber 2, second buckles 26 are respectively disposed at two sides of the power chamber cover plate 6, and the two second buckles 26 are respectively clamped with the two first buckles 25; a rotating column 27 is disposed on each of the side plates 16, a third buckle 28 is disposed on one side of each of the wiring chambers 3, rotating holes 29 are provided on one side of the wiring chamber cover plate 7, and a fourth buckle 30 is disposed on the other side thereof; the rotating columns 27 are rotatably connected to the rotating holes 29; and the fourth buckle 30 is clamped on the third buckles 28. Specifically, due to the two second buckles 26 being respectively clamped with the two first buckles 25, the power chamber cover plate 6 is clamped on the power chamber 2; in addition, the fourth buckle 30 is clamped on the third buckles 28, and the rotating columns 27 are rotatably connected to the rotating holes 29, so that the wiring chamber cover plate 7 can be enabled to rotate on the wiring chambers 3 and be opened a certain angle relative to the wiring chambers 3; and moreover, when the wiring chamber cover plate 7 is closed by reverse rotation, it can be well clamped in the wiring chambers 3.

The foregoing descriptions are merely exemplary embodiments of the present disclosure, and are not intended to limit the patent scope of the present disclosure. Under the inventive concept of the present disclosure, any equivalent structural variations made by using the contents of the description and drawings of the present disclosure, or direct/indirect applications of the contents of the description and drawings in other related technical fields shall be included in the patent protection scope of the present disclosure.

What is claimed is:

1. A power junction box with an adjustment module, comprising: a main body, wherein the main body is internally provided with a power chamber and wiring chambers; the power chamber is internally provided with a circuit board; a power chamber cover plate and a wiring chamber cover plate are disposed on the main body, the power chamber cover plate is configured to cover the power chamber, and the wiring chamber cover plate is configured to cover the wiring chambers; and the power chamber cover plate is provided with the adjustment module and adjusting holes, the adjustment module is located inside the power chamber and is electrically connected to the circuit board, and the adjusting holes correspond to the adjustment module.

2. The power junction box with the adjustment module according to claim 1, wherein the power chamber is spaced apart from the wiring chambers by means of a middle partition, and mounting ports are provided in the middle partition; the mounting ports penetrate between the power chamber and the wiring chambers, each of the mounting port is provided with a wire jacket, and threading holes are reserved in the wire jacket; and the wiring chambers are provided with first knock-out holes.

3. The power junction box with the adjustment module according to claim 2, wherein two side plates are respectively disposed at two sides of the main body, mounting holes and second knock-out holes are reserved in the side plates, and the side plates are in threaded connection with the main body.

4. The power junction box with the adjustment module according to claim 3, wherein positioning blocks are disposed on the side plates and are matched with the middle partition.

5. The power junction box with the adjustment module according to claim 4, wherein each of the side plates is provided with a drain hole, and the wiring chamber cover plate is provided with a waterproof pad located inside the wiring chambers.

6. The power junction box with the adjustment module according to claim 1, wherein there are at least one power chamber and at least two wiring chambers; and an isolating member is configured to separate the two adjacent wiring chambers.

7. The power junction box with the adjustment module according to claim 6, wherein the isolating member is provided with a long-strip connecting hole, and the isolating member is in threaded connection with interiors of the wiring chambers by means of the long-strip connecting hole.

8. The power junction box with the adjustment module according to claim 4, wherein the power chamber cover plate is connected to the main body through one of threaded connection, rotary connection, or clamping connection; and the wiring chamber cover plate is connected to the main body through one of threaded connection, rotary connection, or clamping connection.

9. The power junction box with the adjustment module according to claim 8, wherein first buckles are respectively disposed at two sides of the power chamber, second buckles are respectively disposed at two sides of the power chamber cover plate, and the two second buckles are respectively clamped with the two first buckles.

10. The power junction box with the adjustment module according to claim 8, wherein a rotating column is disposed on each of the side plates, a third buckle is disposed on one side of each of the wiring chambers, rotating holes are provided on one side of the wiring chamber cover plate, and a fourth buckle is disposed on the other side thereof; the rotating columns are rotatably connected to the rotating holes; and the fourth buckle is clamped on the third buckles.
